(19) United States
(12) Patent Application Publication
(10) Pub. No.: US 2012/0212613 A1
(43) Pub. Date: Aug. 23, 2012

(54) VEHICLE VIRTUAL WINDOW SYSTEM, COMPONENTS AND METHOD

(75) Inventors: Toshimitsu Yamaguchi, Irvine, CA (US); Lawrence J. Klementowski, Placentia, CA (US); Timothy A. Dye, New Milfort, CT (US); Mattias E. Nilsson, Huntington Beach, CA (US); Masakazu Sekine, La Habra Heights, CA (US)

(73) Assignee: Sekai Electronics, Inc., La Mirada, CA (US)

(21) Appl. No.: 13/402,821

(22) Filed: Feb. 22, 2012

Related U.S. Application Data
(60) Provisional application No. 61/445,506, filed on Feb. 22, 2011.

(51) Int. Cl. H04N 7/18

(52) U.S. Cl. 348/148; 348/E07.085

(57) ABSTRACT

Embodiments of a virtual window system and method include a plurality of camera and display modules mounted to window openings on a heavy vehicle such as an armored military vehicle. The modules communicate with a base unit which provides electrical power to the assemblies. Each module includes a frame which releasably fixes its module to the vehicle window opening. Each module further includes a display monitor, which may be removed from the vehicle for repair or replacement purposes.

### RELATED APPLICATION

This application is related to Provisional Application Ser. No. 61/445,506, filed Feb. 22, 2011 and entitled VEHICLE VIRTUAL WINDOW SYSTEM, COMPONENTS AND METHOD. Priority is claimed under this provisional, which is incorporated by reference in its entirety.

### FIELD OF THE INVENTION

The present invention relates in general to a virtual window system and method for use on vehicles, and more particularly it also relates to a component of the virtual window system adapted for use in vehicles such as armored vehicles.

### BACKGROUND ART

There is no admission that the background art disclosed in this section legally constitutes prior art.

There have been different types and kinds of armored vehicles such as the ones used in military operations. The vehicles are very heavy in weight by necessity, and thus are not very fuel efficient. Even the windows are excessively heavy in weight in order to be shatterproof, if not bullet proof. Such windows are composed of heavy armored glass and thus are awkward to install, thereby adding to the manufacturing cost of the vehicle.

Therefore, it would be highly desirable to enable armored military vehicles to be constructed of lighter weight materials, without sacrificing protection to the people and equipment located inside the vehicle. By so doing, the lighter weight vehicle would be more cost efficient to operate.

### BRIEF DESCRIPTION OF THE DRAWINGS

The features of this invention and the manner of obtaining them will become apparent, and the invention itself will be best understood by reference to the following description of certain embodiments of the invention taken in conjunction with the accompanying drawings, wherein:

FIG. 1 is a pictorial view of a virtual window system for use in an armored vehicle according to an embodiment the present invention;

FIG. 2 is a partially schematic pictorial view of the virtual window system of FIG. 1;

FIG. 3 is a partial inside view of the vehicle of FIG. 1 illustrating the system of FIG. 1;

FIG. 3A is an enlarged partially broken away view of the circled one of the camera and display modules of FIG. 3; illustrating only the basic components of the module with the mounting components not being shown for sake of clarity;

FIG. 4 is a view similar to FIG. 2 but showing the components in a partially schematic exploded view;

FIG. 5 is an enlarged pictorial view of a camera portion of one of the camera and display assemblies of FIG. 1;

FIG. 6 is an enlarged exploded view of a camera and display module of the system of FIG. 1; and

FIG. 7 is a sectional view of the module of FIG. 5.

### CERTAIN EMBODIMENTS OF THE INVENTION

It will be readily understood that the components of the embodiments as generally described and illustrated in the drawings herein, could be arranged and designed in a wide variety of different configurations. Thus, the following more detailed description of the embodiments of the system, components and method of the present invention, as represented in the drawings, is not intended to limit the scope of the invention, as claimed and disclosed, but is merely representative of the embodiments of the invention.

Embodiments of a virtual window system and method are disclosed and include a plurality of camera and display modules mounted on a heavy vehicle such as an armored military vehicle. The modules communicate with a base unit which provides electrical power to the assemblies.

According to another embodiment of the present invention, a camera and display module or assembly is adapted to be used in a heavy vehicle such as an armored military vehicle. The camera and display module is in the form of a module which is adapted to be mounted in a window opening in a vehicle to enable those seated in the vehicle to view the outside environment of the vehicle. The assembly may be adapted to be used to replace a conventional window in the vehicle, since the inventive module may be substantially lighter in weight than a conventional armored window (not shown) and able to provide other features.

A further embodiment of the invention relates to a method of retrofitting heavy vehicles such as an armored military vehicle window, to render the vehicle lighter in weight. The method includes replacing conventional armored window glass with the camera and display module of an embodiment of the present invention.

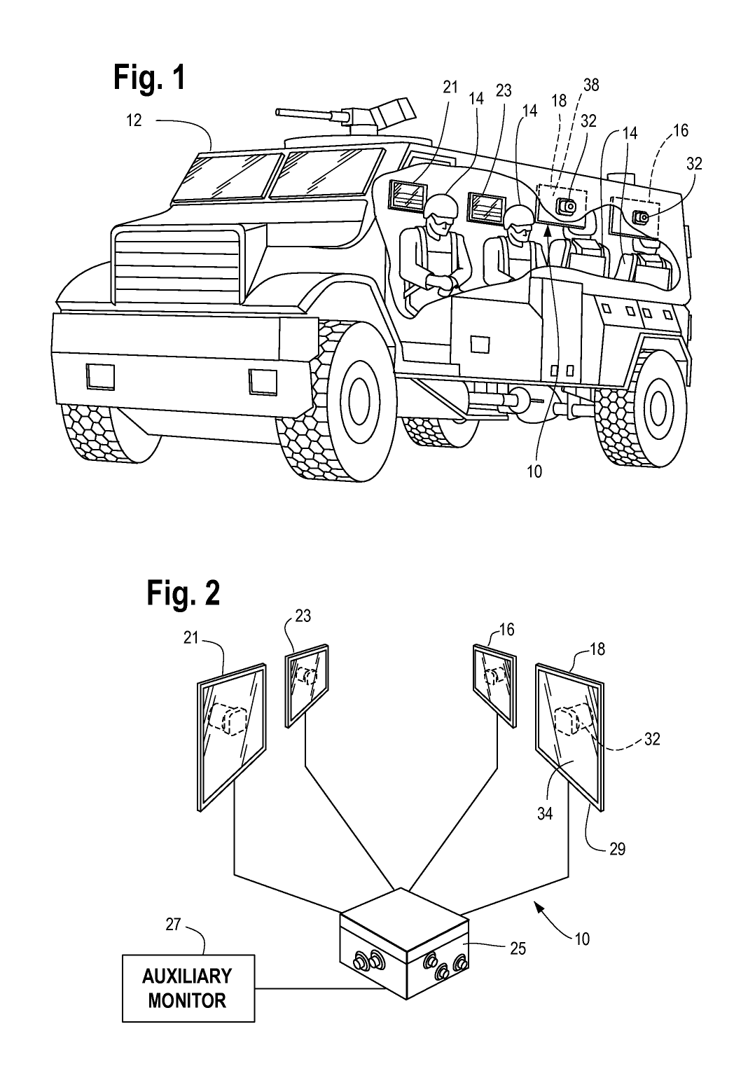

Referring now to the drawings, and more particularly to FIG. 1 thereof, there is disclosed a virtual window system 10, which is constructed in accordance with an embodiment of the invention, and which is adapted to be employed in a vehicle such as an armored military vehicle 12 for carrying passengers such as military personnel 14.

As shown in FIG. 2, the system 10 includes a camera and display assembly or module 16, which is constructed in accordance with an embodiment of the present invention. Similarly, the system 10 also includes three other like modules 18, 21 and 23. The camera and display modules are mounted on the sides of the vehicle 12 and serve as side virtual windows for the personnel 14 to view the surrounding environment as the vehicle 12 travels along the ground. It should be understood that the modules may be mounted at other locations on the vehicle, such as at the rear of the vehicle.

As shown in FIGS. 2 and 4 of the drawings, a power supply base unit 25 provides clean electrical power to each one of the camera and display modules 16, 18, 21 and 23. As shown in FIG. 4, the base unit 25 also is used to provide video signals to a central location such as at an auxiliary monitor 27 which may be disposed within the vehicle 12 to display images generated by the camera and display modules, as well as for recording the video signals. Also, the video signals may also be transmitted wirelessly outside the vehicle to a remote location (not shown).

As seen in FIG. 4 of the drawings, the power supply base unit 25 of the system 10 supplies electrical power to both the camera and display portions of the modules, such as the modules 16, 18, 21 and 23.

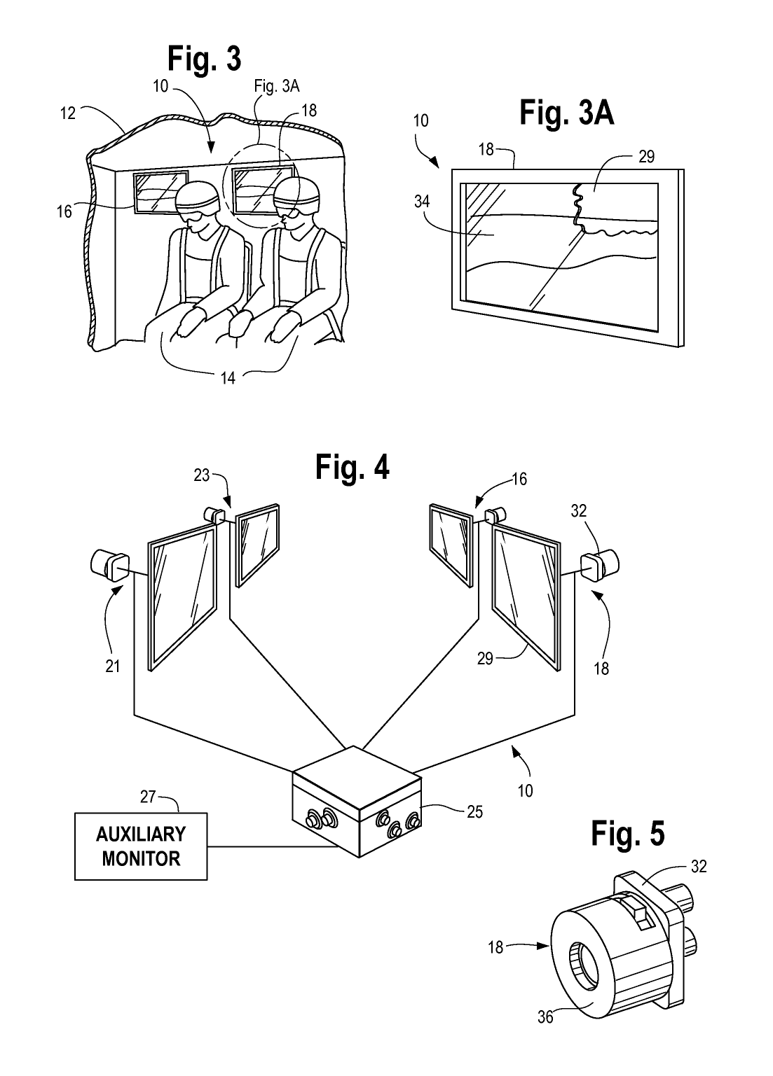

Each one of the camera and display modules are similar to one another and only the assembly 18 will now be described in greater detail. As best shown in FIGS. 3A and 7, the assembly 18 includes a generally rectangular flat panel display monitor 29 which is adapted to face the inside of the vehicle 12 when mounted in place, for presenting a view of the outside environment as best seen in FIG. 3. A camera assembly 32 also forms a part of the module 18 and is adapted to be positioned outside of the vehicle to capture images of the environment as the vehicle 12 moves along the ground. In this regard, the camera assembly 32 are connected electrically to the display monitor 29.

The display monitor 29 may include a hard bonded generally rectangular flat glass sheet 34, which is an anti-reflective reinforced front transparent glass panel covering over the display monitor 29 on the inside of the vehicle 12. The glass sheet 34 may be adhesive hardened.

As shown in FIG. 5, the camera assembly 32 includes a ruggedized camera housing 36, which is cylindrical in shape. The housing 36, as best seen in FIGS. 1 and 7, may be mounted on a generally rectangular armor plate 38 to provide the outside closure for the window opening in the vehicle 12, and the camera housing 36 projects from the plate 38 outside the vehicle. The plate 38 may be composed of any suitable materials such as a heavy metal as for example steel.

The embodiments of the camera and the display modules mount as one-piece units in window openings in the vehicle, such as the heavy vehicle 12, either to replace an existing conventional window, or as original equipment. The modules provide real time viewing of the surrounding environment.

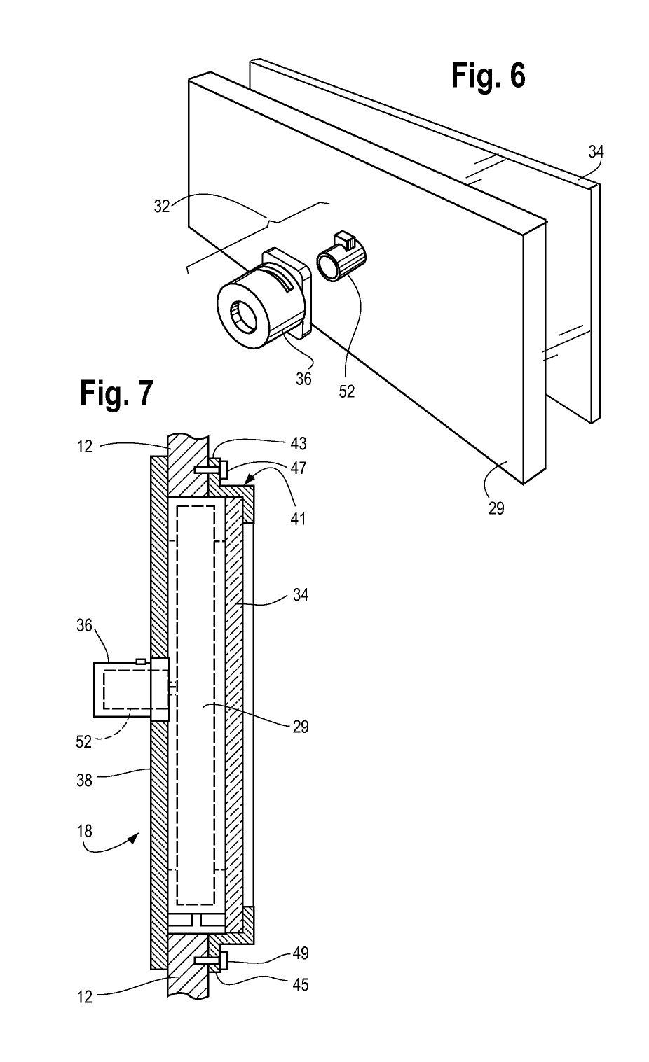

Referring now to FIGS. 6 and 7 of the drawings, the module 18 has its outside armored plate 38 fixed to the vehicle 12 by any suitable fastening technique such as by welding the plate 38 to the metal body of the vehicle 12 surrounding the window opening. The welds may be ground off. Also, other techniques for fastening the plate to the vehicle 12 may also be employed.

Once the plate 38 is fixed in place with its camera assembly 32 located outside the vehicle 12, the display monitor 29 is sized to fit within the window opening adjacent to the panel 38. As best seen in FIG. 7, a frame 41 secures the protective glass sheet 34 in place covering over the display monitor 29 to secure it between the outer plate 38 and the inner transparent sheet 34.

The frame 41 is sized to surround the vehicle window opening and includes an upper upstanding apertured mounting flange 43 and a lower depending apertured mounting flange 45, which are fixed releasably to the body of the vehicle 12 by suitable fasteners such as the screws 47 and 49.

In this manner, the outer plate may be fixed in place first. Then, once the display monitor 29 is disposed in place, the inside the transparent glass sheet 34 is then fixed in place by means of the frame 41 secured to the vehicle by the fasteners such as the screws 47 and 49. The display monitor 29 may be readily observed from the inside of the vehicle 12 through the transparent glass sheet 34.

According to an aspect of an embodiment of the invention, the display monitor 29 may be removed from the module 18 even after it is installed on the vehicle 12 for repair or replacement, by simply removing the fasteners such as the screws 47 and 49.

As best seen in FIG. 6, the camera assembly 32 includes a digital video camera 52 which is mounted inside the ruggedized housing 36 for protecting the camera 52 from damage, as well as from adverse weather conditions. The outer housing 36 is generally cylindrical in shape and is hollow for receiving the video camera 52 therein. The housing 36 includes a central opening in front, to expose the lens of the camera 52 to view. A base flange plate is adapted to secure the housing 36 and the camera 52 to the plate 38 by suitable means (not shown).

A prior known all weather video camera unit is disclosed in U.S. published patent application U.S. 2006/0230570, which serves as a curved windshield and includes rubber blades for cleaning the camera lens. However, it is not intended to be a system as disclosed herein for heavy vehicles such as armored military vehicles.

While particular embodiments have been shown and described, it is to be understood that various different modifications are possible and are contemplated. There is no intention to be limited to the exact embodiments disclosed herein.

What is claimed is:

1. A vehicle virtual window system for a heavy vehicle, comprising:
a plurality of camera and display modules for viewing the outside environment of the vehicle by people seated within the vehicle; and
a power supply base unit for supplying electrical power to the assemblies and for conveying video signals from the assemblies to remote locations.

2. The virtual window system of claim 1, wherein the plurality of camera and display modules are mounted within openings on a vehicle.

3. The virtual window system of claim 2, wherein the camera and display modules are mounted on the sides of the vehicle to serve as side windows to allow said vehicles passengers to view the surrounding environment of the vehicle.

4. The virtual window system of claim 1, wherein said power supply base unit provides clean electrical power to each one of said camera and display modules.

5. The virtual window system of claim 1, wherein said power supply base unit is used to provide video signals to a remote location or to a central location within the vehicle.

6. The virtual window system of claim 1, further including an auxiliary monitor to display images generated by the camera and display modules.

7. The virtual window system of claim 6, wherein the auxiliary monitor is disposed within the vehicle.

8. The virtual window system of claim 1, wherein the camera and display modules each include a flat panel display monitor that faces the inside of the vehicle for presenting a view of the outside environment.

9. The virtual window system of claim 1, wherein the monitor includes a bonded glass sheet composed of an anti-reflective reinforced glass.

10. The virtual window system of claim 1, wherein each module includes a camera assembly having a ruggedized camera housing.

11. The virtual window system of claim 10, wherein the ruggedized camera housing is cylindrical in shape.

12. The virtual window system of claim 11, wherein the ruggedized camera assembly is mounted on an armor plate to provide the outside closure for the window opening in the vehicle.

13. The virtual window system of claim 11, wherein the ruggedized camera housing projects from the armor plate outside the vehicle.

14. The virtual window system of claim 1, wherein the camera and display modules mount as one-piece units in window openings of the vehicle to provide real time viewing of the surrounding environment.

15. A method of providing virtual windows in a heavy vehicle, comprising:
fixedly mounting a plate having a camera assembly to a window opening in the vehicle; and
securing a display monitor adjacent to the plate within the window opening by securing a frame holding a transparent sheet over the window opening inside the vehicle.

16. The method of claim 15, wherein the securing of the frame for the transparent sheet includes using removable fasteners so that the display monitor may be removed or replaced after initial installation on the vehicle.

17. A camera and display module for mounting to a heavy vehicle, comprising:
a camera assembly mounted to a plate for fitting to a window opening on the vehicle;
a display monitor sized to fit within the window opening; and
a frame having a transparent sheet secured therein for attaching releasably fixedly to the inside of the vehicle to secure the display monitor in place for viewing inside the vehicle, the monitor being electrically connected to the camera assembly for viewing images captured by the camera assembly on the monitor.

18. A camera and display module according to claim 17, wherein the frame is sized to surround the window opening and includes apertured flanges for securing to the inside of the vehicle.

19. A camera and display module according to claim 17, wherein the camera assembly, includes a digital video camera disposed inside of a ruggetized housing.
